(19) United States
(12) Patent Application Publication
(10) Pub. No.: US 2008/0243272 A1
(43) Pub. Date: Oct. 2, 2008

(54) Positioning apparatus

(75) Inventor: Kazuhiro Shibatani, Osaka (JP)

Correspondence Address: BRINKS HOFER GILSON & LIONE, P.O. BOX 10395, CHICAGO, IL, 60610, US

(73) Assignee: KONICA MINOLTA OPTO, INC.

(21) Appl. No.: 12/079,032

(22) Filed: Mar. 24, 2008

(30) Foreign Application Priority Data
Mar. 30, 2007 (JP) JP2007-091768

(51) Int. Cl. G05B 19/18

(52) U.S. Cl. 700/59; 700/57

(57) ABSTRACT

A position apparatus capable of positioning a moving member even in the situation with a large initial misalignment. This positioning apparatus includes a moving member driven by a drive 4; a position detector for outputting a maximum detection output when the moving member is at a predetermined position; and a controller 10. The controller 10 controls the drive device 4 based on the output of the second amplifier 23, whose amplification factor is greater than that of the first amplifier 22, when the output of the second amplifier 23 is equal to or less than a predetermined switching threshold, and otherwise the controller controls the drive device 4 based on the output of the first amplifier.

This application is based on Japanese Patent Application No. 2007-091768 filed on Mar. 30, 2007, in Japanese Patent Office, the entire content of which is hereby incorporated by reference.

### TECHNICAL FIELD

The present invention relates to a positioning apparatus.

### BACKGROUND

For example, Unexamined Japanese Patent Application Publication No. 2003-338795 discloses a laser apparatus where a laser beam emitted from a light source such as a laser oscillator is led by an optical element such as a lens into a light receiving member such as an optical fiber in alignment therewith. The output of such a laser apparatus is known to exhibit a Gaussian distribution with reference to the alignment error of the laser beam.

Unexamined Japanese Patent Application Publication No. 2003-338795 discloses a method called wobbling, where in order to position the laser beam with respect to the optical fiber, an optical element is wobbled at a predetermined period with a predetermined amplitude to measure a change in the intensity of the outputted laser beam from the optical fiber, and calculation is made to obtain the direction and distance of the movement of the optical element required to maximize the intensity of received laser beam.

Another conventionally known art is the control technique called a mountain climbing control, where, in the aforementioned laser apparatus, the optical element is moved a predetermined distance to check whether or not there is an increase in the intensity of received light, and the optical element is continuously moved by a predetermined distance in the direction where the intensity of received light increases until the intensity of received light starts to decrease.

In the alignment control of the laser apparatus, if the laser beam is much deviated from the light receiving member, a change in the intensity of received light will be reduced below the resolution of the analog-to-digital conversion or the variation of error. This causes a failure in adequate calculation of how much the optical element is to be moved.

[Patent Document 1] Unexamined Japanese Patent Application Publication No. H06-265759

### SUMMARY

The object of the present invention is to solve the aforementioned problem, and to provide a positioning apparatus capable of positioning the moving member in such a way as to maximize the detection output even when the initial position has a large error.

In view of forgoing, one embodiment according to one aspect of the present invention is a positioning apparatus, comprising:

a moving member;

a drive device for moving the moving member within a predetermined movable range;

a position detection section for outputting a detection output which is at a maximum when the moving member is at a predetermined target position; and

a controller for controlling the drive device so that the detection output of the position detection section is at a maximum; the controller including:
a first amplifier for amplifying the detection output; and
a second amplifier for amplifying the detection output, the second amplifier having an amplification factor greater than an amplification factor of the first amplifier in a region in which the detection output is equal to or less than a predetermined level;

wherein the controller controls the drive device based on an output of the second amplifier when the output of the second amplifier is not greater than a predetermined switching threshold, and the controller controls the drive device based on an output of the first amplifier when the output of the second amplifier is greater than the switching threshold.

According to another aspect of the present invention, another embodiment is a positioning apparatus, comprising:

a moving member;

a drive device for moving the moving member within a predetermined movable range;

a position detection section for outputting a detection output which is at a maximum when the moving member is at a predetermined target position; and

a controller for controlling the drive device so that the detection output of the position detection section is at a maximum; the controller including:
an amplifier for amplifying the detection output, an amplification factor of the amplifier being set, in a region in which the detection output is higher than a predetermined level, to a first amplification factor and otherwise set to a second amplification factor greater than the first amplification factor, and the amplifier being for selectively outputting a first output amplified by the first amplification factor and a second output amplified by the second amplification factor;

wherein the controller controls the drive device based on the second output when the second output is not greater than a predetermined switching threshold, and the controller controls the drive device based on the first output when the second output is greater than the switching threshold.

### BRIEF DESCRIPTION OF THE DRAWINGS

FIG. 1 is a schematic diagram representing a positioning apparatus as according to a first embodiment of the present invention;

FIG. 2 is a schematic diagram representing a drive device of the positioning apparatus of FIG. 1;

FIG. 3 is a block diagram representing the arrangement of a controller of FIG. 1;

FIG. 4 is a flow diagram representing the control of the controller of FIG. 3;

FIG. 5 is a diagram representing the locus of the moving lens in the positioning apparatus of FIG. 1;

FIG. 6 is a diagram showing the relationship between the position of the moving lens in the movable range and the output of the amplifiers in the positioning apparatus of FIG. 1;

FIG. 7 is a schematic view showing positioning apparatus according to a second embodiment of the present invention;

FIG. 8 is a block diagram representing the arrangement of the controller of FIG. 7; and

FIG. 9 is a diagram representing the relationship between the position of the moving lens and the output of the amplifiers in the positioning apparatus of FIG. 7.

### DETAILED DESCRIPTION OF THE PREFERRED EMBODIMENT

The following describes the embodiment of the present invention with reference to drawings:

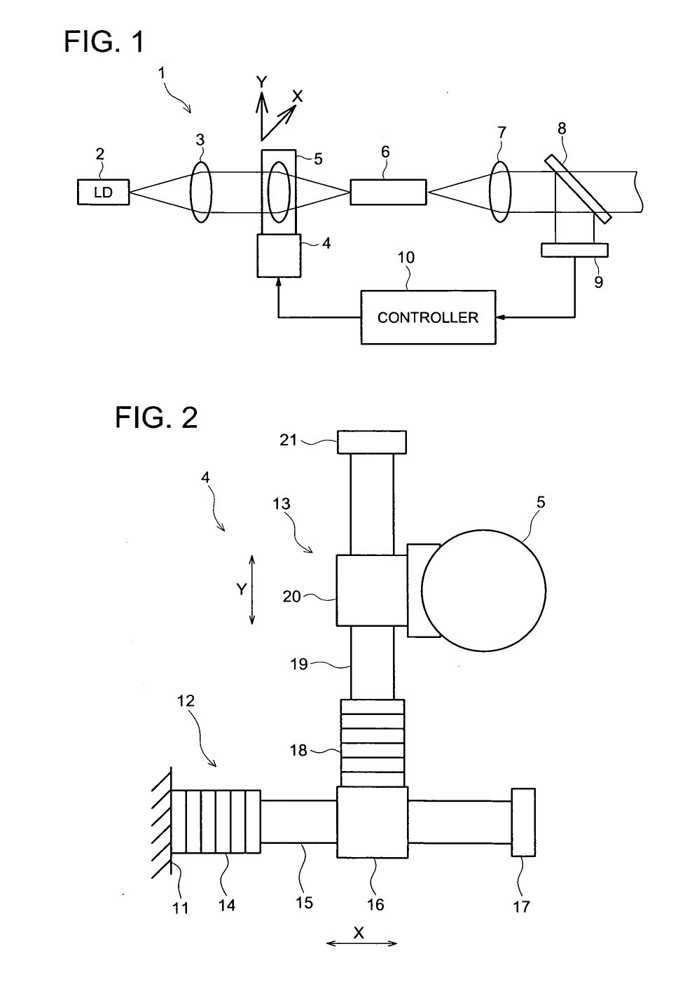

FIG. 1 is a diagram representing a positioning apparatus 1 according to a first embodiment of the present invention. The positioning apparatus 1 includes a laser diode 2 for emitting a laser beam; a converging lens such as a fixed projection lens 3; a moving lens (moving member) 5 that can be moved in the X-Y direction perpendicular to the laser beam by a drive device 4; a light receiving member such as a second harmonic generation element 6 through which the laser beam goes via the projection lens 3 and moving lens 5; an emitting lens 7 for emitting the output of the second harmonic generation element 6; a half mirror 8 for dividing the output of the second harmonic generation element 6 into tow components; a power monitor 9 such as a photodetector which converts the divided component of the output of the second harmonic generation element 6 into an electric signal (detection output); and a controller 10 for moving the moving lens 5 in the Y-Y direction in response to the detection output of the power monitor 9. The light receiving member and the photodetector are included in a position detection section.

The second harmonic generation element 6 has the light receiving section having a diameter of about 1 through 3 μm. The moving lens 5 converges the laser beam so that the diameter of the laser beam is the same as that of the light receiving section of the second harmonic generation element 6, and ensures that the optical axis of the laser beam is aligned with the center of the light receiving section of the second harmonic generation element 6.

If the optical axis of the laser beam is aligned with the center of the light receiving section of the second harmonic generation element 6 with the moving lens 5 positioned at a predetermined target position, all the energy of laser beam is inputted into the second harmonic generation element 6. Thus, the output of the second harmonic generation element 6 is maximized, and the detection output of the power monitor 9 is also maximized.

FIG. 2 shows the arrangement of the drive device 4 that drives the moving lens 5. The drive device 4 includes an X-axis actuator 12 fixed onto a enclosure 11, and a Y-axis actuator 13 which is moved in the X-axis direction by the X-axis actuator 12 and which drives the moving lens 5 in the Y-axis direction.

The X-axis actuator 12 includes an X-axis piezoelectric element 14 whose one end is fixed to the enclosure 11 and which expands and contracts in the X-axis direction when voltage is applied or removed; an X-axis drive shaft 15 that is reciprocally driven in the X-axis direction by the expansion and contraction of the X-axis piezoelectric element 14; an X-axis friction engagement member 16 that is engaged with the X-axis drive shaft 15 by friction; and an X-axis stopper 17 provided at the end of the X-axis drive shaft 15. The Y-axis actuator 13 has a one end fixed to the X-axis friction engagement member 16, and includes an Y-axis piezoelectric element 18 which expands and contracts in the Y-axis direction when voltage is applied of removed; a Y-axis drive shaft 19 that is reciprocally driven in the Y-axis direction by the expansion and contraction of the Y-axis piezoelectric element 18; a Y-axis friction engagement member 20 engaged with the Y-axis drive shaft 19 by friction; and an Y-axis stopper 21 provided at the end of the Y-axis drive shaft 19. The moving lens 5 is supported by the Y-axis friction engagement member 20. The X-axis friction engagement member 16 can be moved in a range between the X-axis piezoelectric element 14 and X-axis stopper 17 as a movable range, and the Y-axis friction engagement member 20 moves in a rage between the Y-axis piezoelectric element 18 and Y-axis stopper 21 as a movable range.

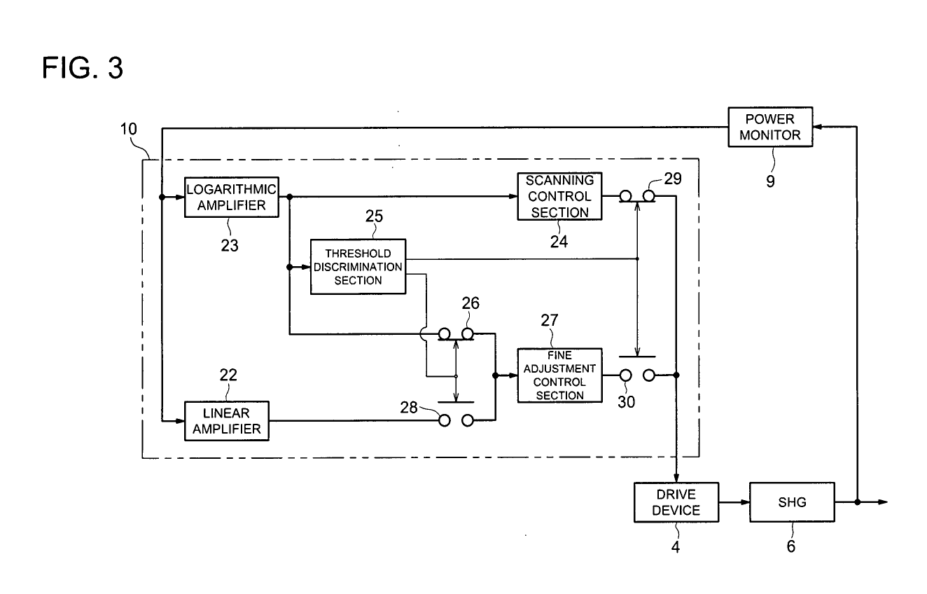

FIG. 3 shows the arrangement of the controller 10. The controller 10 has a linear amplifier (the first amplifier) 22 where the detection output of the power monitor 9 is inputted, and a compression amplifier such as a logarithmic amplifier (the second amplifier) 23. The linear amplifier 22 is a linear amplifier for amplifying the detection output at a predetermined amplification factor, and the logarithmic amplifier 23 is an amplifier for logarithmic transformation of the detection output.

The controller 10 includes a scanning control section 24, a threshold discrimination section 25 and switch 26 into each of which the output of the logarithmic amplifier 23 is inputted; and a fine adjustment control section 27 where the output of the logarithmic amplifier 23 is inputted upon closing of the switch 26. Further, the output of the linear amplifier 22 is inputted into the fine adjustment control section 27 through the switch 28 that operates in the opposite phase to that of the switch 26. The output of the scanning control section 24 is inputted into the lens drive device 4 when a switch 29 is closed. The output of the fine adjustment control section 27 is inputted into the lens drive device 4 upon closing of the switch 30 that operates in the opposite phase to that of the switch 29.

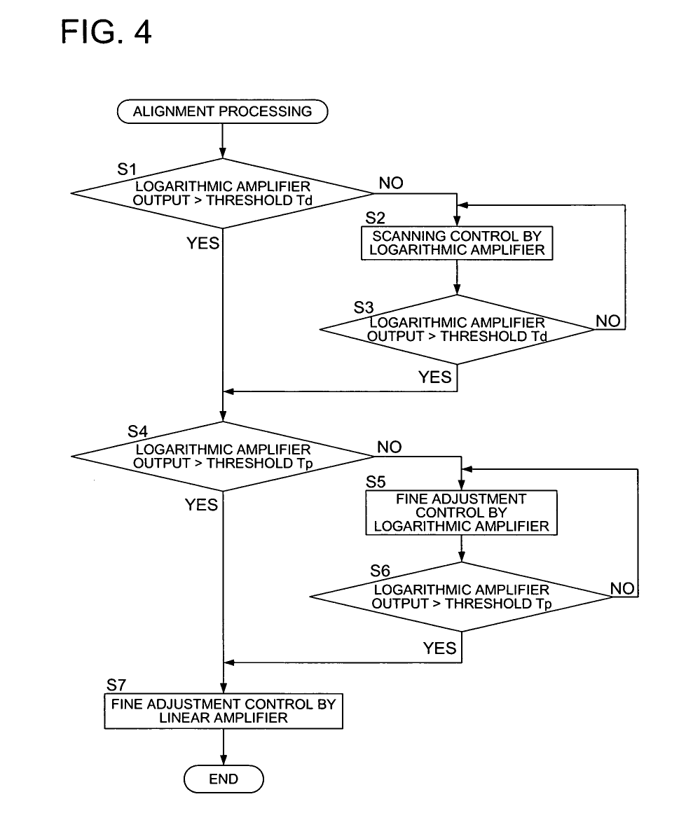

FIG. 4 shows the control flow of the drive device 4 in the controller 10 of the present invention. In the first place, alignment of the moving lens 5 is started by the positioning apparatus 1. Then in Step S1, the threshold discrimination section 25 verifies whether or not the output of the logarithmic amplifier 23 is greater than a predetermined fine adjustment starting threshold Td. If the output of the logarithmic amplifier 23 is not greater than the fine adjustment starting threshold Td, the system goes to the Step S2, and a scanning control is provided in such a way that the moving lens 5 is pitch-fed in the X-Y directions while the output of the logarithmic amplifier 23 is monitored by the scanning control section 24.

When the system goes to the Step S2, the threshold discrimination section 25 operates in such a way that the switch 29 is closed (switch 30 is opened) and the output of the scanning control section 24 is inputted into the drive device 4.

If it has been verified in Step S3 that the output of the logarithmic amplifier 3 is greater than the fine adjustment starting threshold Td, the system goes to Step S4. If it has been found out in Step S3 that the output of the logarithmic amplifier 23 is not greater than the fine adjustment starting threshold Td, the system goes to Step S2 to repeat the scanning control to pitch-feed the moving lens 5.

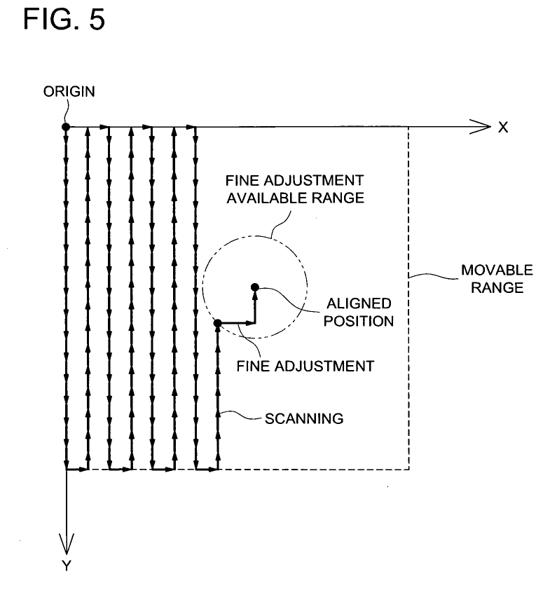

As shown in FIG. 5, in the scanning control by the scanning control section 24, the moving lens 5 is first reset to the origin at the end of the movable range. After that, the moving lens 5 is moved along a predetermined path repeatedly at a predetermined pitch. In the present embodiment, the Y-axis is assumed as indicating the main scanning direction, while the X-axis is considered as indicating the sub-scanning direction. To be more specific, the moving lens 5 is driven from the origin in the Y-axis direction repeatedly at a predetermined pitch. When it has reached the opposite side of the movable range, the moving lens 5 is fed by just one pitch in the X-axis direction. Then it is fed in the Y-axis direction repeatedly by one pitch. When it has again reached the end in the Y-axis direction, it is further driven by one pitch in the X-axis direction. After that, the moving lens 5 is again pitch-fed in the Y-axis direction by reversing the direction. The threshold discrimination section 25 checks the output of the logarithmic amplifier 23 in Step S3 every time the moving lens 5 is fed one pitch in the X-axis direction or in the Y-axis direction by the drive device 4.

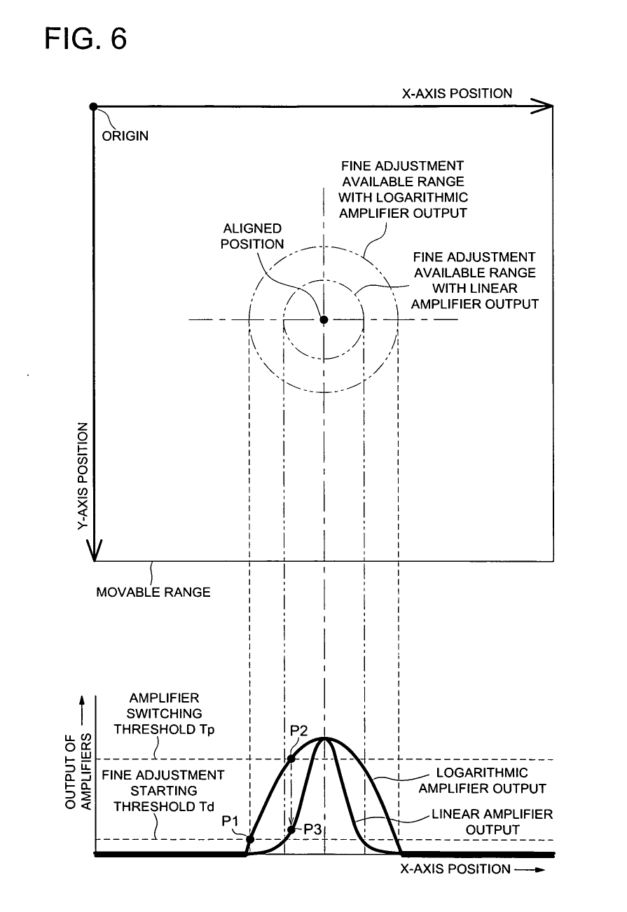

FIG. 6 shows the relationship between the position of the moving lens S and the output of the linear amplifier 22 and logarithmic amplifier 23. The design is so configured that the output of the logarithmic amplifier 23 is zero volt if the input voltage is below the predetermined level. The effective range of the logarithmic amplifier 23 is set as to cover the range where the output of the linear amplifier 22 is identified to be not zero.

With consideration given to the resolution of the analog-to-digital conversion for calculation by the scanning control section 24 and fine adjustment control section 27, and errors in the detection output of the power monitor 9, the fine adjustment starting threshold Td is set at such a value to ensure stable detection of a change in the output of the logarithmic amplifier 23, in response to a very small displacement of the moving lens 5, for accurate identification of the change rate in the output of the log amplifier 23 at that position of the moving lens 5.

In FIG. 4, if the output of the logarithmic amplifier 23 is greater than the fine adjustment starting threshold Td in the Step S1 or Step S3, it means that the moving lens 5 is located within the range where fine adjustment (wobbling) of the moving lens 5 is possible by the logarithmic amplifier output of FIG. 6 (P1). Thus, the system goes to the Step S4, and the threshold discrimination section 25 checks whether or not the output of the logarithmic amplifier 23 is greater than a predetermined amplifier switching threshold Tp. If the output of the logarithmic amplifier 23 is not greater than the amplifier switching threshold Tp, the system goes to the Step S5, and a fine adjustment control with wobbling is provided in such a way that the moving distance of the moving lens 5 is determined by the scanning control section 24 according to the change in the output of the logarithmic amplifier 23.

When the system goes to Step S5, the threshold discrimination section 25 operates in such a way to open the switch 29 and close the switch 30, and to input the output of the fine adjustment control section 27 into the drive device 4.

If it is verified in Step S6 that the output of the logarithmic amplifier 23 is greater than the amplifier switching threshold Tp, the system goes to the Step S7. If it is verified in Step S6 that the output of the logarithmic amplifier 23 is not greater than the amplifier switching threshold Tp, the system goes to the Step S5, and the fine adjustment control is repeated in Step S5 in such a way that the moving lens 5 is wobbled according to the output of the logarithmic amplifier 23.

In the wobbling method, the moving lens 5 is moved back and forth by a predetermined small distance to detect a change in the detection output. Then the moving lens 5 is driven by the distance corresponding to the change in the detection output multiplied by a predetermined coefficient. When the moving lens 5 is located at the aligned position, the change rate of the detection output is zero, and hence the moving lens 5 can be converged to the aligned position by the wobbling method.

When the moving lens 5 is located close to the aligned position, the change rate in the output of the logarithmic amplifier 23 is reduced below that in the output of the linear amplifier 22. Thus, in the present embodiment, when the output of the logarithmic amplifier 23 is greater than the amplifier switching threshold Tp in Step S6, the system goes to Step S7, and the similar fine adjustment (wobbling) control is provided according to the change in the output of the linear amplifier 22.

When the system goes to the Step S7, the threshold discrimination section 25 operates in such a way to open the switch 26 and close the switch 28, whereby the output of the linear amplifier 22 is inputted into the fine adjustment control section 27.

The amplifier switching threshold Tp is set at the output level of the logarithmic amplifier 23 with the moving lens 5 located at the position where the change rate in the output of the linear amplifier 22 (P3 of FIG. 6) becomes greater than that in the output of the logarithmic amplifier 23 (P2 of FIG. 6), and the change rate in the output of the linear amplifier 22 (P3 of FIG. 6) gets to be able to be accurately detected by wobbling drive.

Thus, even when the moving lens 5 is located in the vicinity of the aligned position, and a change in the output of the log amplified 23 resulting from a small vibration by the wobbling drive is reduced below the potential difference corresponding to the minimum bit of the analog-to-digital conversion, the moving lens 5 can be moved closer to the aligned position where the detection output is maximized, by fine adjustment using the output of the liner amplifier 22 of greater change rate.

Unless the operation of the positioning apparatus 1 is interrupted, the wobbling is repeated in Step S7 moving the moving lens 5 toward the aligned position on a continuous basis. This procedure ensures that the detection output is kept at the maximum level.

The positioning apparatus 1 first provides the scanning control and the fine adjustment control based on the output of the logarithmic amplifier 23. This arrangement ensures two advantages of a wider range where fine adjustment is available and a shorter time for moving the moving lens 5 within the range where fine adjustment is possible. Further, in the case that only the output of the linear amplifier 22 is utilized, if the feed distance per pitch were large in the scanning control, the range possible of fine adjustment might be jumped over. This may lead to a failure in detecting the aligned position. However, a wider range where fine adjustment is available is ensured by the use of the output of the logarithmic amplifier 23. This makes it possible to increase the pitch of feed in the scanning control and to find out the fine adjustment available range in a short period of time.

In the aforementioned control section of the present invention, when the output of the aforementioned second amplifier is not greater than a predetermined fine adjustment starting threshold, a scanning control is provided in such a way that the aforementioned moving member is first reset to the origin, and the aforementioned moving member is then moved at a predetermined pitch within the aforementioned movable range sequentially from one end until the output of the aforementioned second amplifier is increased over a predetermined fine adjustment starting threshold. When the output of the aforementioned second amplifier is greater than a predetermined fine adjustment starting threshold, and is not greater than the aforementioned switching threshold, a fine adjustment is provided in such a way that the traveling distance of the aforementioned moving member is determined based on the change in the output of the aforementioned second amplifier.

According to the arrangement of the present embodiment, even when the misalignment of the moving member is so large in a large movable range that the detection output is zero, the moving member can be moved to the position where the detection output is obtained by scanning the moving member until the output of the aforementioned second amplifier is first increased over the predetermined fine adjustment starting threshold. After that, fine adjustment is performed first using the second amplifier that enables positioning even if the detection output is small. This is followed by the step of using the first amplifier to perform the fine adjustment to ensure accurate positioning. Further, since the range where fine adjustment is available by the second amplifier is large, the peak position of the detection output is not jumped over, even if the pitch of moving the moving member is large in the scanning control.

In the embodiment of the present invention, in the range where accurate positioning cannot be provided by the first amplifier because of a small change rate in the detection output, the position is determined by using the second amplifier having a higher amplification factor than that of the first amplifier. This arrangement expands the positioning range of the fine adjustment.

If a linear amplifier is used as the first amplifier and a logarithmic amplifier is used as the second amplifier as in the case of the present embodiment, the output having a greater change rate can be obtained when the change rate of the detection output is small. When the change rate of the output of the logarithmic amplifier is small, use of the linear amplifier provides the output having a greater change rate.

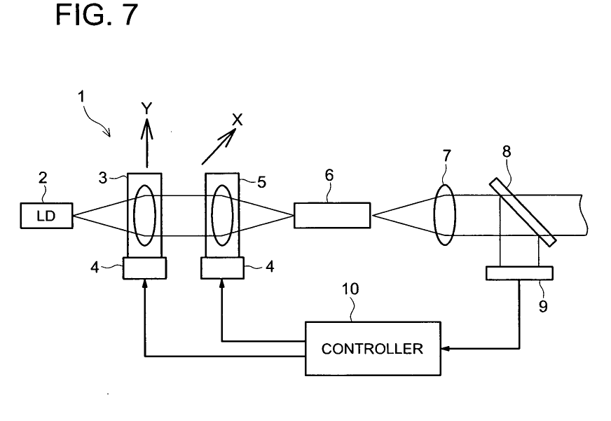

In the present invention, as in the second embodiment illustrated in FIG. 7, the projection lens 3 is used as the first moving member, and can be driven in the Y-axis direction. The moving lens 5 is used as the second moving member and can be driven in the X-axis direction.

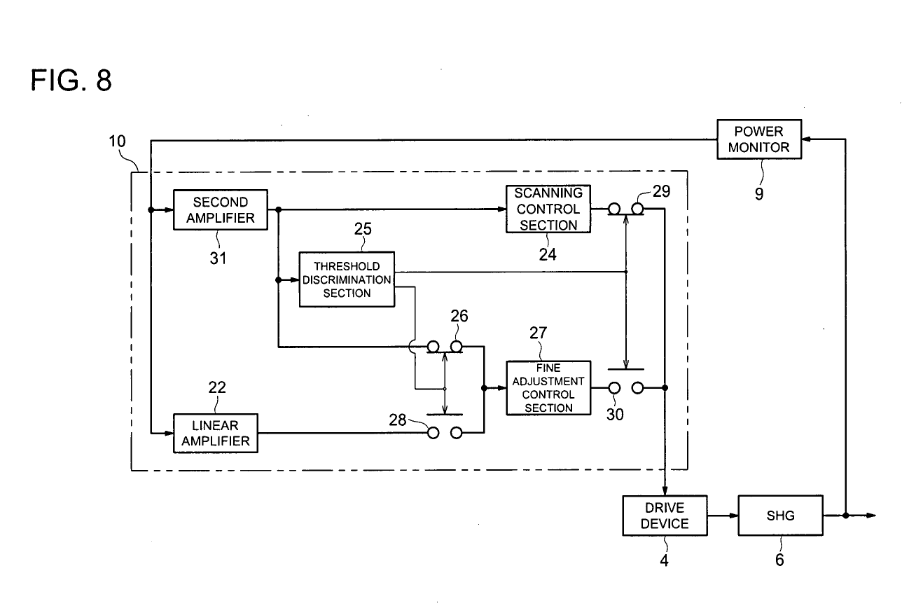

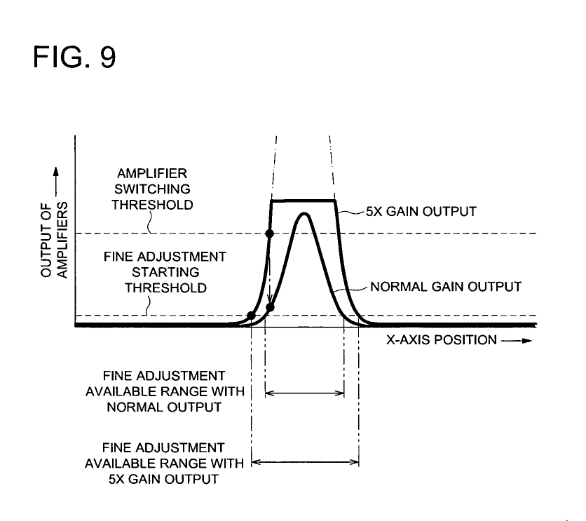

As shown in FIG. 8, the present embodiment includes the second amplifier 31 having a linear gain which is five times as high as that of the linear amplifier 22, instead of the logarithmic amplifier 23 of the first embodiment. The linear amplifier 22 and the second amplifier 31 have the output characteristics illustrated in FIG. 9.

When the moving lens 5 is located close to the aligned position, the second amplifier 31 is assumed as producing the output swinging over its effective output range (i.e., exceeding the effective amplifier output range or analog-to-digital conversion range) and having been peak-cut. However, when the output of the second amplifier 31 has exceeded the amplifier switching threshold Tp, the output of the linear amplifier 22 is used for control. Thus, the output of the second amplifier 31 having exceeded the range is not employed, and therefore, no problem occurs. Conversely, that the output of the second amplifier 23 is to swing over its range means that the output of the linear amplifier 22 is designed to make an extensive use of the effective range of the scanning control section 24 and fine adjustment control section 27.

In the present embodiment, by using the second amplifier 31 having a greater gain, the range possible of fine adjustment control is expanded beyond the range in case of using the linear amplifier 22.

Further, by using the linear amplifier where gain can be switched by the threshold discrimination section 25, a single amplifier can serve the functions of two amplifiers, the linear amplifier 22 and the second amplifier 31. To be more specific, the first amplifier 22 and second amplifier 23 of the present invention may not be physically independent of each other.

According to this arrangement, in the case that the detection output has such an output property as Gaussian distribution with respect to the position of the moving member, even when the detection output and its change rate are small, it is possible to position the moving member by amplifying a change in the detection output by using the second amplifier. When the detection output is large, the output of the second amplifier swings over the range or the change rate of the amplifier output is small, the positioning control is impossible by using only the output of the second amplifier. However, this arrangement allows an appropriate control by switching to the first amplifier.

In the present invention, it is also possible to make such arrangements that a third amplifier is provided where the amplification factor is higher than that of the second amplifier 23. When the moving lens 5 is located far away from the aligned position, a scanning control and a fine adjustment control may be provided first based on the output of the third amplifier.

Without being restricted to the aforementioned embodiment, the present invention is also applicable to the positioning apparatus where only one axis is movable, and the positioning apparatus where positioning of three or more axes is enabled.

The present invention is applicable not only to the alignment of laser beam, but also to the case where the actuator is reset to the origin, for example, based on the output of the hall device. In this case, it is also possible to make such an arrangement that the origin resetting is determined to have been completed and the wobbling is terminated when the change in detection output at the time of fine feed in the wobbling mode becomes lower than or equal to the predetermined threshold.

In the present invention, instead of wobbling technique, it is also possible to use the conventionally known control technique such as the mountain climbing operation where the moving member is driven so as to maximize the detection output.

What is claimed is:

1. A positioning apparatus, comprising:
a moving member;
a drive device for moving the moving member within a predetermined movable range;
a position detection section for outputting a detection output which is at a maximum when the moving member is at a predetermined target position; and
a controller for controlling the drive device so that the detection output of the position detection section is at a maximum; the controller including:
a first amplifier for amplifying the detection output; and
a second amplifier for amplifying the detection output, the second amplifier having an amplification factor greater than an amplification factor of the first amplifier in a region in which the detection output is equal to or less than a predetermined level;
wherein the controller controls the drive device based on an output of the second amplifier when the output of the second amplifier is not greater than a predetermined switching threshold, and the controller controls the drive device based on an output of the first amplifier when the output of the second amplifier is greater than the switching threshold.

2. The positioning apparatus of claim 1, wherein the moving member includes:
an optical element for transferring therethrough an incident laser beam,
and the position detection section includes:
a light receiving member for receiving on a first end thereof the laser beam transferred through the optical element and emitting the received laser beam from a second end thereof; and
a photodetector for receiving at least a part of the laser beam emitted form the second end of the light receiving member to output the detection output depending on an intensity of the laser beam received thereby.

3. The positioning apparatus of claim 2, wherein the optical element includes a converging lens unit for converging the incident laser beam into a spot on the first end of the light receiving member, and the light receiving member includes an optical fiber or a waveguide.

4. The positioning apparatus of claim 3, wherein when the output of the second amplifier is not greater than a predetermined fine adjustment starting threshold, the controller drives the moving member to an origin of the movable range and then executes a scan control in which the moving member is scanned with a predetermined pitch until the output of the second amplifier becomes greater than the fine adjustment starting threshold, and when the output of the second amplifier is greater than the fine adjustment starting threshold and not greater than the switching threshold, the controller executes a fine adjustment control in which the moving member is moved by a distance which is determined by the controller based on the output of the second amplifier.

5. The positioning apparatus of claim 1, wherein when the output of the second amplifier is not greater than a predetermined fine adjustment starting threshold, the controller drives the moving member to an origin of the movable range and then executes a scanning control in which the moving member is scanned with a predetermined pitch until the output of the second amplifier becomes greater than the fine adjustment starting threshold, and when the output of the second amplifier is greater than the fine adjustment starting threshold and not greater than the switching threshold, the controller executes a fine adjustment control in which the moving member is moved by a distance which is determined by the controller based on the output of the second amplifier.

6. The positioning apparatus of claim 1, wherein the detection output has a Gaussian distribution with respect to a position of the moving member, the Gaussian distribution being centered at the predetermined target position.

7. The positioning apparatus of claim 1, wherein the first amplifier is a linear amplifier, and the second amplifier is a compression amplifier.

8. The positioning apparatus of claim 7, wherein the compression amplifier is a logarithmic compression amplifier.

9. The positioning apparatus of claim 1, wherein when the moving member is in a vicinity of the predetermined target position, the output of the second amplifier swings over a range in which the output of the second amplifier is effective.

10. A positioning apparatus, comprising:
a moving member;
a drive device for moving the moving member within a predetermined movable range;
a position detection section for outputting a detection output which is at a maximum when the moving member is at a predetermined target position; and
a controller for controlling the drive device so that the detection output of the position detection section is at a maximum; the controller including:
an amplifier for amplifying the detection output, an amplification factor of the amplifier being set, in a region in which the detection output is higher than a predetermined level, to a first amplification factor and otherwise set to a second amplification factor greater than the first amplification factor, and the amplifier being for selectively outputting a first output amplified by the first amplification factor and a second output amplified by the second amplification factor;
wherein the controller controls the drive device based on the second output when the second output is not greater than a predetermined switching threshold, and the controller controls the drive device based on the first output when the second output is greater than the switching threshold.

11. The positioning apparatus of claim 10, wherein the moving member includes:
an optical element for transferring therethrough an incident laser beam,
and the position detection section includes:
a light receiving member for receiving on a first end thereof the laser beam transferred through the optical element and emitting the received laser beam from a second end thereof; and
a photodetector for receiving at least a part of the laser beam emitted form the second end of the light receiving member to output the detection output depending on an intensity of the laser beam received thereby.

12. The positioning apparatus of claim 11, wherein the optical element includes a converging lens unit for converging the laser beam into a spot on the first end of the light receiving member,
and the light receiving member includes an optical fiber or a waveguide.

13. The positioning apparatus of claim 12, wherein when the second output is not greater than a predetermined fine adjustment starting threshold, the controller drives the moving member to an origin of the movable range and then executes a scanning control in which the moving member is scanned with a predetermined pitch until the second output becomes greater than the fine adjustment starting threshold, and when the second output is greater than the fine adjustment starting threshold and not greater than the switching threshold, the controller executes a fine adjustment control in which the moving member is moved by a distance which is determined by the controller based on the second output.

14. The positioning apparatus of claim 10, wherein when the second output is not greater than a predetermined fine adjustment starting threshold, the controller drives the moving member to an origin of the movable range and then executes a scanning control in which the moving member is scanned with a predetermined pitch until the second output becomes greater than the fine adjustment starting threshold, and when the second output is greater than the fine adjustment starting threshold and not greater than the switching threshold, the controller executes a fine adjustment control in which the moving member is moved by a distance which is determined by the controller based on the second output.

15. The positioning apparatus of claim 10, wherein when the moving member is in a vicinity of the predetermined target position, the second output swings over a range in which the second output is effective.
